(19) United States
(12) Patent Application Publication
(10) Pub. No.: US 2007/0149249 A1
(43) Pub. Date: Jun. 28, 2007

(54) METHOD AND APPARATUS FOR EFFICIENT CONFIGURATION OF HYBRID SUB-CARRIER ALLOCATION

(75) Inventors: John S. Chen, Downingtown, PA (US); Robert L. Olesen, Huntington, NY (US); Guodong Zhang, Farmingdale, NY (US); Sung-Hyuk Shin, Northvale, NJ (US); Junsung Lim, River Edge, NJ (US); Arty Chandra, Manhasset Hills, NY (US); Sudheer A. Grandhi, Mamaroneck, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/608,477

(22) Filed: Dec. 8, 2006

Related U.S. Application Data
(60) Provisional application No. 60/753,129, filed on Dec. 22, 2005.

(51) Int. Cl. H04B 1/38

(52) U.S. Cl. 455/561

(57) ABSTRACT

In an orthogonal frequency division multiple access (OFDMA) system including at least one base station and at least one wireless transmit/receive unit (WTRU), sub-carriers are allocated for data transmissions to multiple access WTRUs, where sub-carriers are allocated according to a consecutive sub-carrier allocation (CSA) type and a distributed sub-carrier allocation (DSA) type. Pilot signals with distributed pilot sub-carriers are transmitted and measured at each WTRU to obtain a channel quality metric for each pilot sub-carrier. Each WTRU sends feedback to the base station reporting channel quality based on the measured channel quality metrics. An allocation type is selected and adaptively switched according to channel variations in time and frequency domain.

### CROSS REFERENCE TO RELATED APPLICATION

This application claims the benefit of U.S. Provisional Application No. 60/753,129 filed Dec. 22, 2005, which is incorporated by reference as if fully set forth.

### FIELD OF INVENTION

The present invention relates to an orthogonal frequency division multiple access (OFDMA) system including at least one base station and at least one wireless transmit/receive unit (WTRU), (e.g., a mobile station). More particularly, the present invention relates to a method and apparatus for providing the capability of hybrid sub-carrier allocation for data transmissions by a base station to multiple access WTRUs, and controlling pilot measurement messages, (i.e., channel quality indicators (CQIs)), for multiple pilot sub-carriers.

### BACKGROUND

OFDMA is a promising multiple access scheme for future generation wireless communication systems, such as long term evolution (LTE) Third Generation Partnership Project (3GPP) and IEEE 802.16 systems. FIG. 1 shows a conventional OFDMA system 100 including at least one base station 105 and a plurality of WTRUs 110₁, 110₂, . . . , 110_{N}. In the OFDMA system 100, a wide bandwidth is divided into multiple narrowband sub-carriers, and the base station 105 coordinates the allocation of the sub-carriers to the plurality of WTRUs 110₁, 110₂, . . . , 110_{N}. The sub-carriers comprise pilot sub-carriers, data sub-carriers, and null sub-carriers. In general, the base station 105 sends the pilot signals with the sub-carriers distributed over the entire bandwidth, so that each WTRU 110 uses the pilot sub-carriers to estimate the channel quality of nearby data sub-carriers.

For data transmission, consecutive sub-carrier allocation (CSA) and distributed sub-carrier allocation (DSA) are used to allocate sub-carriers. In CSA, several consecutive sub-carriers comprise one cluster as a basic unit of allocation. One cluster may contain one or several pilot sub-carriers. At least one cluster is allocated to a selected WTRU 110. The base station 105 generally attempts to assign the cluster to the WTRU 110 that has the best channel on a given cluster at a given time. The clusters assigned to a WTRU 110 may not be consecutive. In DSA, the assigned sub-carriers to a WTRU 110 are distributed over the entire bandwidth, so that they are no longer consecutive, although they need not be equally spaced. The position of sub-carriers or clusters can follow a pseudo random pattern to average interference.

In a radio environment, wide bandwidths may experience frequency selective fading. When the base station 105 sends information to one or multiple WTRUs 110 on the downlink, the channel gains vary for different sub-carriers, and the channels are uncorrelated or less correlated for different WTRUs 110. Therefore, a cluster which is in a deep frequency selective fade for one WTRU 110 may be in a satisfactory channel condition for the other WTRU 110. By strategically assigning clusters to WTRUs 110 that have good channel conditions, the effects of frequency selective fading can not only be mitigated, but in fact leveraged for better performance. These CSA methods can increase channel efficiency (bits/Hz) by applying higher constellation schemes for some sub-carriers. However, CSA with an adaptive modulation scheme requires a large amount of feedback from the WTRUs 110 to the base station 105 in order to relay the channel qualities of all or selected clusters. The large amount of feedback is even more problematic when considering the fast response necessary for a time varying channel as well as the large overhead of the CQI for multiple pilot sub-carriers. Furthermore, CSA can operate incorrectly on a fast-moving WTRU 110 due to the difficulty of tracking its channel variation.

On the other hand, there are some sub-carrier allocations which employ frequency diversity to combat channel variation by distributing the sub-carriers across a larger portion of the frequency band. These DSA methods obtain frequency diversity and gain of interference averaging by distributing the assigned sub-carriers. In DSA, a common modulation scheme can be employed to all sub-carriers assigned to a WTRU 110, thereby decreasing the overhead in feedback information from the WTRU 110, since the WTRU 110 may send a representative channel quality indicator instead of individual indicators. Different modulation schemes can be applied to the assigned sub-carriers in DSA. In this case, the quality of a particular sub-carrier can be estimated using the CQI of the pilot sub-carriers neighboring the data sub-carrier, though this would necessitate the large overhead of pilot sub-carrier CQI measurements attributed to CSA. DSA is beneficial in terms of interference averaging and frequency diversity, but it decreases the channel efficiency due to the spreading of the sub-carriers.

In the downlink of the OFDMA wireless communication system 100, the base station 105 transmits pilot signals with distributed pilot sub-carriers. Each WTRU 110 measures the channel quality, (i.e., received signal strength, signal-to-interference-plus-noise ratio (SINR)), for each pilot sub-carrier, and reports the quality for each. Alternatively, it may be able to report the channel quality of each cluster by interpolating or combining the channel qualities of the pilot sub-carriers contained in the cluster, instead of the individual quality of each pilot sub-carrier, in order to reduce overhead. The channel qualities of data sub-carriers are also determined by interpolating the channel qualities of pilot sub-carriers in the time and frequency domain.

In the following descriptions, it is assumed that the WTRU 110 is able to estimate channel quality by cluster and send the channel quality indicators back for all or some of the selected clusters. Upon receiving feedback information, the base station 105 further selects some of the WTRUs 110 and allocates sub-carriers or clusters to each selected WTRU 110 with a particular sub-carrier allocation algorithm: DSA or CSA. For these two dimensional resource allocations in the time and sub-carrier domain, the base station 105 may utilize additional information such as traffic loading, priorities, or buffer delay.

Consider the case of CSA, wherein at least one cluster is allocated to a selected WTRU 110 when the cluster has favorable channel conditions for the WTRU 110, relative to other WTRUs 110. To determine the assignment, the base station 105 uses the CQI of the cluster for all candidate WTRUs 110 and selects one WTRU 110 through a time-scheduling algorithm considering various factors such as CQI and fairness. The sub-carriers in a cluster are consecutive, but the allocated clusters themselves are not necessarily consecutive. Different modulation schemes can be applied to different clusters based on the CQI estimates of the clusters. Each WTRU 110 is required to send the CQIs for at least one selected cluster, which leads to a large overhead in uplink control signaling.

DSA refers to the selected sub-carriers or clusters for a WTRU 110 which are distributed over the entire bandwidth. DSA is considered in units of sub-carriers so that the sub-carriers in a cluster are allocated to different WTRUs 110. The distribution pattern of the sub-carriers assigned to a WTRU 110 may be a predetermined pseudo random pattern. The locations of sub-carriers for a WTRU 110 may, as a function of time, change to other locations as with frequency hopping OFDMA. The sub-carriers allocated to a WTRU 110 can have different modulation schemes applied to them. Each sub-carrier assigned to a WTRU 110 adapts its modulation scheme individually based on the CQI of the cluster containing the sub-carrier. In this case, the uplink overhead from the WTRU 110 to the base station 105 would be the same as the uplink overhead for CSA. Alternatively, a common modulation scheme can be applied to all assigned sub-carriers to a WTRU 110. In this case, the WTRU 110 would send a typical CQI representing the channel quality for the overall bandwidth instead of the individual CQIs, thereby reducing the large overhead in uplink signaling.

### SUMMARY

The present invention is related to an OFDMA system including at least one base station and at least one WTRU. Sub-carriers are allocated for data transmissions to multiple access WTRUs, where sub-carriers are allocated according to a CSA type and a DSA type. Pilot signals with distributed pilot sub-carriers are transmitted and measured at each WTRU to obtain a channel quality metric for each pilot sub-carrier. Each WTRU sends feedback to the base station reporting channel quality based on the measured channel quality metrics. An allocation type is selected and adaptively switched according to channel variations in time and frequency domain.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a conventional OFDMA wireless communication system;

FIG. 2 is a block diagram of a base station configured to perform hybrid sub-carrier allocation in accordance with the present invention;

FIG. 3 shows an example of adaptive sub-carrier allocations for three WTRUs in accordance with the present invention;

FIG. 4 is a flow diagram of a process of determining whether CSA or DSA channel allocation should be implemented; and

FIG. 5 shows signaling between a base station and a plurality of WTRUs in accordance with the present invention.

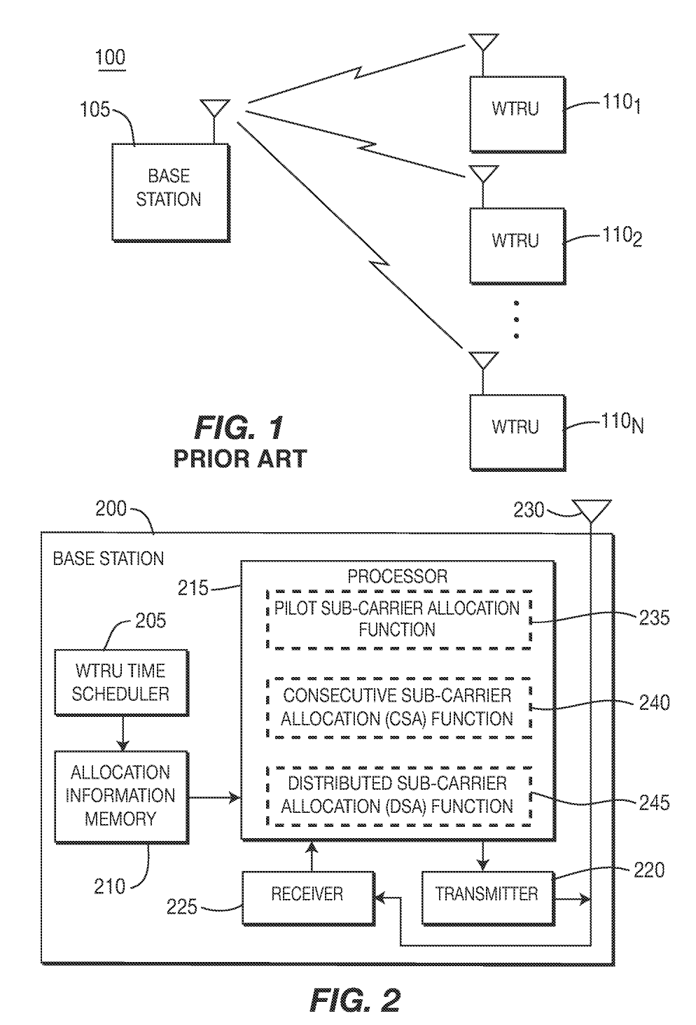

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment.

When referred to hereafter, the terminology “base station” includes but is not limited to a Node-B, a site controller, an access point (AP), or any other type of interfacing device capable of operating in a wireless environment.

The features of the present invention may be incorporated into an integrated circuit (IC) or be configured in a circuit comprising a multitude of interconnecting components.

The following describes how a base station can provide CSA or DSA. Typically, some WTRUs are configured for CSA allocations and others are simultaneously configured for DSA allocations. The base station and WTRUs also have the capability to reconfigure allocation mode dynamically.

FIG. 2 is a block diagram of a base station 200 configured to perform hybrid sub-carrier allocation in accordance with the present invention. The base station includes a WTRU time scheduler 205, an allocation information memory 202, a processor 215, a transmitter 220 a receiver 225 and an antenna 230. The processor 215 performs a pilot sub-carrier allocation function 235, a CSA function 240 and a DSA function 245 in accordance with the present invention. The transmitter 220 controls adaptive modulation and feedback information received from at least one WTRU.

The WTRU time scheduler 205 inputs allocation information into the memory 210. The allocation information may identify a set of WTRUs to which downlink resources are to be assigned. The allocation information also indicates CSA, DSA or both CSA and DSA for each of the WTRUs in the identified set of WTRUs. The allocation information also includes other relevant allocation information, such as the desired size of the resource allocation for each WTRU.

The processor 215 performs a pilot sub-carrier allocation function 235. The pilot sub-carriers may be statically allocated for long periods of time.

The processor 215 works in conjunction with the allocation information memory 210 and the transmitter 220 to assign consecutive sub-carriers to the WTRUs that are designated as CSA. A WTRU may be assigned a set of sub-carriers containing pilot sub-carriers. Since the WTRU knows which sub-carriers are pilots, the WTRU knows that the sub-carriers will not be used for data transmission/reception.

The processor 215 works in conjunction with the allocation information memory 210 and the transmitter 220 to assign the remaining sub-carriers, (i.e., the subcarriers which have not been assigned to a CSA WTRU), to the WTRUs that are designated as DSA. Again, the assigned subcarriers may contain pilots since every WTRU knows which sub-carriers are pilots. The base station 200 notifies each WTRU of its resource assignment via the transmitter 220 and the antenna 230.

One or more WTRUs are selected in the WTRU time scheduler 205 at a given time. Then, the selected WTRUs are split into two groups based on their allocation type. The WTRUs newly admitted to the system can start initially with DSA or CSA. The transmitter 220 in the base station 200 generates control signals to notify the CSA WTRUs regarding the assigned clusters. The transmitter 220 in the base station 200 generates control signals to notify the DSA WTRUs regarding the distributed patterns and the clusters used. The receiver 225 receives feedback, (e.g., CQIs) from the WTRUs via the antenna 230 and forwards the received feedback to the processor 215, such that the processor 215 can determine whether each WTRU has a large variation or a small variation in the frequency domain.

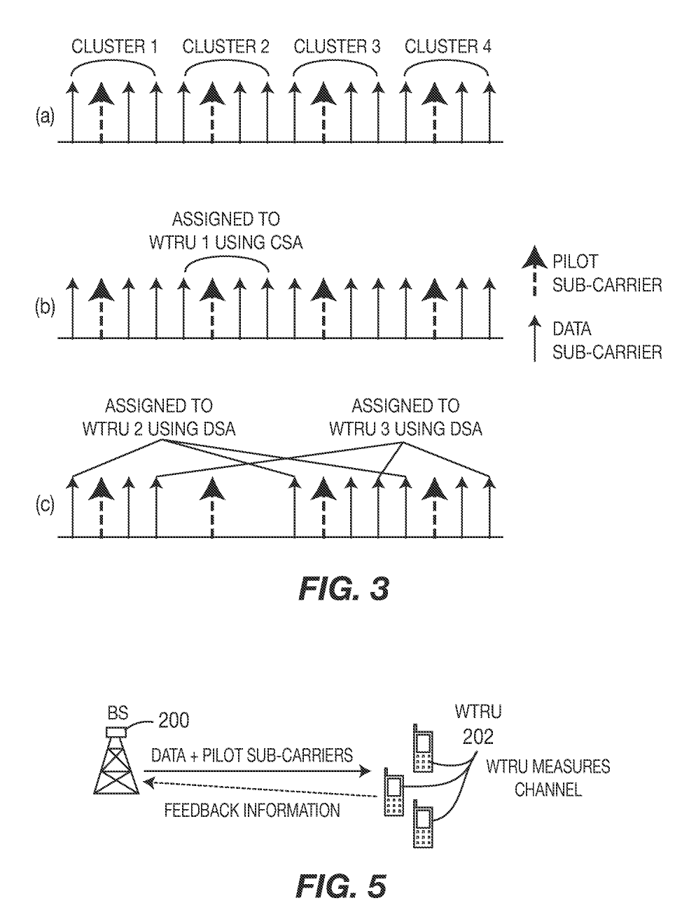

FIG. 3 shows an example of sub-carrier allocations. In this example, there are three (3) WTRUs selected by the WTRU time scheduler 205 of the base station 200 at a certain time instance: WTRU 1 (CSA), WTRU 2 (DSA) and WTRU 3 (DSA). The base station 200 first assigns clusters to WTRU 1 in CSA mode. By using any CSA algorithms based on CQI feedback from WTRU 1, cluster 2 is assigned to WTRU 1 according to this example, as shown in FIG. 3(a). Next, the base station 200 assigns some of the remaining sub-carriers to WTRU 2 or WTRU 3 using a DSA algorithm, as shown in FIG. 3(b). DSA algorithms may be designed to distribute the assigned sub-carriers to each WTRU fairly over the entire sub-carrier range excluding sub-carriers assigned to the WTRUs in CSA mode, as shown in FIG. 3(c).

Although the description of the present invention focuses on downlink signaling, the present invention also applies to uplink signaling with uplink pilots, as well as ad-hoc, (i.e., mesh), networks.

There are challenges in designing a wireless communication system that optimally employs CSAIDSA and efficiently switches between CSA and DSA for each WTRU. In particular, it is challenging to minimize the control signaling for channel quality feedback while maintaining the effectiveness of the aforementioned hybrid CSA/DSA wireless communication system. The present invention provides a framework that minimizes control signaling in an effective CSA/DSA resource allocation scheme.

The first part of this framework is based on time and frequency variation measurements of pilot sub-carriers. These measurements are used to efficiently control key aspects of this communication system. In one embodiment of the aforementioned measurement-based method, the adaptive switching of sub-carrier allocation is controlled by characterizing time and frequency domain channel characteristics to each WTRU. In another embodiment, the measurements are used to affect the quantity of CQI that is fed back to the base station 200.

The second part of the framework provides intelligent methods for controlling channel feedback in an adaptive manner so that more feedback is sent from a WTRU when it is most beneficial to that WTRU. The techniques disclosed herein are described using the downlink of an OFDMA system as an example. However, it can apply to any multi-carrier system and any multiple access scheme where a wide bandwidth is partitioned into multiple clusters, with one or several clusters used for a particular WTRU.

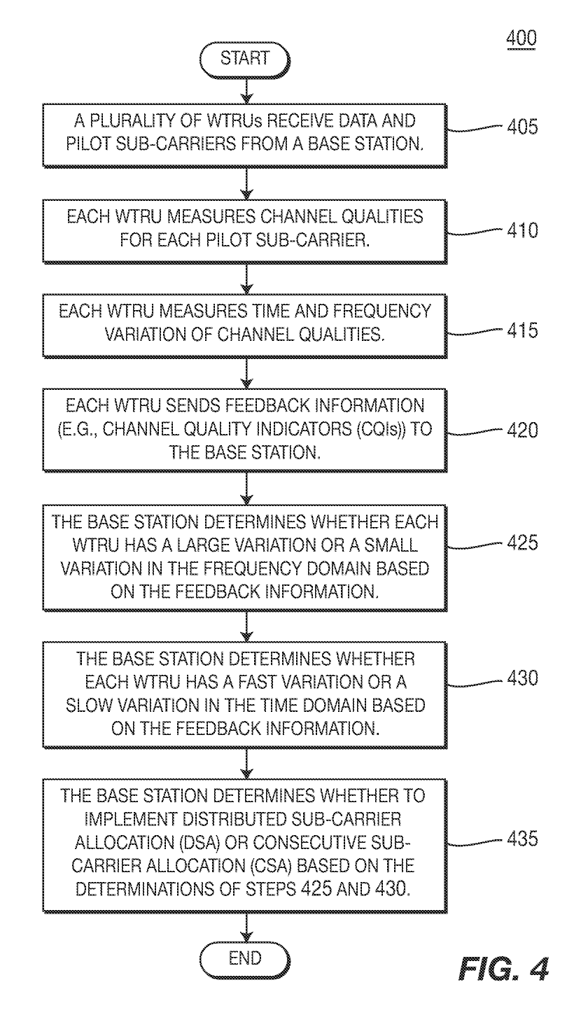

FIG. 4 is a flow diagram of a process 400 of determining whether CSA or DSA channel allocation should be implemented in a wireless communication system shown in FIG. 5. In step 405, a plurality of WTRUs 202 receive data and pilot sub-carriers from a base station 200. In step 410, each WTRU 202 measures channel qualities for each pilot sub-carrier. In step 415, each WTRU 202 measures time and frequency variation of channel qualities. In step 420, each WTRU 202 sends feedback information, (e.g., CQIs), to the base station 200. The feedback information sent by an individual WTRU is derived from measurements of the time and frequency variation of channel qualities performed by the individual WTRU in step 415. In step 425, the base station 200 determines whether each WTRU 202 has a large variation or a small variation in the frequency domain based on the feedback information. In step 430, the base station 200 determines whether each WTRU has a fast variation or a slow variation in the time domain based on the feedback information. In step 435, the base station determines whether to implement DSA or CSA based on the determinations of steps 425 and 430.

As described above, measurements are made of the time and the frequency variation, (sub-carrier variation), of a wide bandwidth for downlink. The measurement values can be reported to the base station 200 in addition to the channel quality indicator.

A time variation, Vt, may be derived from measuring the variation of channel quality, (i.e., SINR), of one or several pilot sub-carriers in the time domain at a WTRU 202, (i.e., standard deviation in time domain). The combined value considering time variances of multiple pilot sub-carriers is one embodiment.

A frequency variation, Vf, represents frequency variation of channel qualities between the pilot sub-carriers at a time instance. The standard deviation between the channel qualities of the pilot sub-carriers can be a factor.

It is preferred that different control functions may use different metrics derived from measurements of Vt and Vf. Specific embodiments will be described, but here are some representative examples:

Metric 1—Take an action if max({Vt})>threshold A and max({Vf})>threshold B, where A and B are preconfigured constants and {Vt}, {Vf} are a set of measurements over a defined time window; and

Metric 2—Take an action if the most recent Vt>threshold A, where A is a predefined constant.

According to the present invention, it is preferred that hysteresis may be used in conjunction with metrics derived from Vt and Vf. For example, take an action if Vt>threshold A, and reverse the action if Vt<threshold B, where A>B.

Vt and Vf are measured at the WTRU 202, and in a preferred embodiment, the WTRU 202 autonomously takes an action based on the measurements. In another embodiment, the WTRU 202 reports information derived from Vt and Vf to the base station 200. As one example, this information is the measurements Vt and Vf themselves. As another example, this information is one bit indicating whether Vt has exceeded a given threshold and another bit indicating whether Vf has exceeded another threshold.

In accordance with another embodiment of the present invention, the threshold metric is also used to inform the base station 200 to switch transmission modes, e.g., from transmit diversity to precoding, or visa versa.

As the concept of metrics derived from measurements of Vt and Vf to control behavior has been introduced above, the base station 200 may configure the metrics so that the WTRUs 202 may evaluate the metrics. In a first example, the base station 200 sends the WTRU 202 the values of the thresholds A and B given above. As another example, the base station 200 sends the metric itself through a predefined formal language. The base station 200 may send the same configuration to all WTRUs 202, send different configurations to each individual WTRU 202, or send configurations to classes of WTRUs 202, (e.g., QoS level of applications running on the WTRU 202). Configuration by the base station 200 has the following benefits:

1) reduced signaling overhead from the WTRU 202 to the base station 200;

2) assuming that the WTRU 202 has access to the necessary related information, it can autonomously take actions based on the measurements, (e.g., it can make an autonomous decision on CSA vs. DSA, but it may not be able to make scheduling decisions because generally the WTRU 202 does not have status from other WTRUs 202; and

3) behavior can be dynamic based on varying conditions such as base station load.

Alternatively, (or optionally), to the above embodiment in which the WTRU 202 determines Vt and Vf and reports them to the base station 200. The base station 200 may autonomously perform/determine the Vt and Vf measurements (or a similar kind of measurements) based on the reported CQI measurements (and/or other feedback information) from the WTRU 202. In the case, the signaling overhead of the Vt and Vf measurements from the WTRU 202 can be reduced or avoided.

The following two definitions for channel characteristics will be useful later.

Fast time variation/slow time variation: A WTRU is defined as having a fast time varying channel when the time variation (Vt) is greater than a preconfigured value T_fast. Otherwise, the channel is defined as having a slow time varying channel when the time variation (Vt) is smaller than a predetermined value T_slow.

Large frequency variation/small frequency variation: A WTRU is defined as having a large frequency varying channel when the frequency variation (Vf) is greater than a preconfigured value F_large. Otherwise, the channel is defined as having a small varying channel when the frequency variation (Vf) is smaller than a predetermined value F_small.

As mentioned above, hysteresis can be used in each of the two definitions, i.e., T_slow<T_fast and/or F_small<F_large. Also, the base station 200 may configure T_slow, T_fast, F_small, and F_large. Alternatively, a single threshold value may be used where T_slow=T_fast, and where F_small=F_large.

Specific embodiments in relation to DSA/CSA switching will now be described. In one embodiment, the WTRU 202 reports Vt and Vf periodically, and the base station 200 decides whether the WTRU 202 should have CSA or DSA channel allocations. In a second embodiment, the WTRU 202 sends the base station 200 the definition for the channel characteristics, and again the base station 200 determines the channel allocation type. In a third embodiment, the WTRU 202 decides if it should have CSA or DSA allocations. As an example, the allocation type can be determined by the channel characteristics as shown in Table 1 below.

TABLE 1

| Channel characteristics | Type |
|---|---|
| Vt > T_fast, Vf > F_large | DSA |
| Vt > T_fast, Vf < F_small | DSA |
| Vt < T_slow, Vf > F_large | CSA |
| Vt < T_slow, Vf < F_small | DSA |

The cluster size may vary based on Vt and Vf. Thus, rather than making a hard selection of CSA versus DSA, there may be several discrete options between a completely localized and completely distributed allocation.

Preferably, the clusters are coordinated for the WTRUs 202 in the CSA mode prior to the WTRUs 202 in the DSA mode. Excluding the assigned clusters to the WTRUs in the CSA mode, the clusters or sub-carriers are coordinated for the WTRUs in DSA mode. In an alternate embodiment, in a given time interval the base station 200 transmits to either CSA or DSA type WTRUs. In other words, there exists only one mode, (either DSA or CSA, but not both), in a time interval, but the mode switching for the two groups can be done on a time interval basis in a dynamic manner.

The WTRU 202 reports a CQI of each cluster by interpolating and combining the channel quality values of the pilot sub-carriers contained in or closely adjacent to the cluster. The frequency resolution and the time resolution of CQI reporting is controlled in order reduce the overhead of the resultant uplink control signaling. Further, Vt and Vf are used as a basis for this control.

According to the present invention, controlling the frequency resolution of CQI reports involves using Vt and Vf. The preferred embodiment is for the WTRU 202 to report the values of Vt and Vf so that the base station 200 may use these values to control CQI frequency resolution, but this does not preclude other alternatives as presented above. The frequency resolution control defines the following parameters:

1) The number of required CQIs (N);

2) Index of the clusters which the base station 200 wants to receive from each WTRU;

3) a request of all CQIs for the entire cluster or N=the total number of clusters; or

4) any combination with above three parameters.

Two representative examples include reporting a CQI for every cluster individually, so N=total number of clusters, and reporting a single CQI value that is representative of all clusters, so N=1 and every cluster index is included.

It is preferred that the time resolution of CQI reporting is controlled using Vt and Vf. For example, the time resolution can depend on the value of time variation (Vt), (i.e., CQI will be reported more frequently when Vt is high).

As formulated above, one embodiment is for the WTRU 202 to autonomously control its frequency resolution and/or time resolution of CQI reports. Alternatively, the WTRU 202 can send Vt and Vf or some derived metrics of Vt and Vf to the base station 200. The base station 200 would then signal the frequency and/or time resolution control values to the WTRU 202.

The pilot sub-carriers can consist of common pilot sub-carriers and additional pilot sub-carriers. As a basic mode, the base station 200 allocates the common pilot sub-carriers by permuting in time and frequency domain. Additional sub-carriers, (time domain and frequency domain), may be allocated in addition to the common pilot sub-carriers if more precise channel estimation is required in the time or frequency domain. The present invention controls pilot sub-carrier allocation by considering channel variations. In a preferred embodiment, pilot sub-carrier allocation is controlled by considering Vt and Vf of the connected WTRUs 202. Considering the value of Vt and Vf of at least one WTRU 202, the base station 200 determines the set of the additional pilot sub-carriers. In a preferred embodiment, the base station 200 sets additional pilot sub-carriers if the maximum values of Vt and Vf received from a given fraction or number of the WTRUs 202 exceed predetermined values Pt_fast and Pf_fast over a given time window. Additionally, hysteresis may be applied in reducing the number of pilots. Specifically, the base station 200 de-allocates additional pilot sub-carriers if the maximum values of Vt and Vf is less than predetermined values Pt_slow and Pf_slow, where Pt_slow<Pt_fast and/or Pf_slow<Pf_fast. Alternatively, a single threshold value is used such that Pt_slow=Pt_fast. The base station 200 notifies the information of pilot sub-carrier allocation to the WTRUs 202 through downlink control channel. Note that pilot sub-carrier allocation cannot be done at the WTRU 202 since the pilots are transmitted by the base station 200, and the base station 200 should make a joint decision by considering all of its connected WTRUs 202.

According to the present invention, the granularity, (and therefore the quantity), of feedback for Vt, Vf, CQI, and related signaling, (which hereafter shall be referred to collectively as channel feedback), varies based on anticipated traffic activity. Thus, the longer a WTRU 202 goes without having traffic activity, the less feedback it sends to the base station 200.

If a CQI contains channel state information, a minimum amount of feedback will be required regardless of traffic activity. The rate of feedback is modified to account for channel state information when precoding is used at the base station 200. The minimum amount of feedback required for this case will be determined by the channel state information latency, or a similar measure of error induced by channel state information.

For CSA type allocations, it is preferred that the channel feedback may stop or be sent with low granularity until a traffic channel is assigned. Once a traffic channel is assigned, channel feedback will be sent so that a better traffic channel, (i.e., a different set of sub-carriers), may be established. In one embodiment, the QoS levels of WTRU traffic are incorporated so that high priority traffic may bypass this mechanism, and the WTRUs 202 with such traffic would send CQI reports at regular intervals.

Channel variation in time and frequency domain may be either supplanted with or replaced by subscriber speed or Doppler spread measurements, which may be performed at the base station. All of the above embodiments may use Doppler spread or subscriber speed measurements in place of, or in addition to, time and frequency variation measurements.

It is also preferred according to the present invention to use predictive transmission of channel feedback. At the base station 200, this is realized by requesting a given WTRU 202 to send channel feedback when the resource scheduler of the base station 200 anticipates that it will grant a channel for that WTRU 202. At the WTRU 202, this is realized by sending channel feedback when its buffer of data to be transmitted exceeds a threshold, (possibly 0).

The present invention applies to a communication between a base station 200 and a WTRU 202, and may be implemented at the physical layer, (radio or digital baseband), or the data link layer, as hardware or software.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment, terminal, base station, radio network controller, or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A base station which operates in an orthogonal frequency division multiple access (OFDMA) system including at least one wireless transmit/receive unit (WTRU), the base station comprising:
(a) a WTRU time scheduler;
(b) an allocation information memory electrically coupled to the WTRU time scheduler for receiving allocation information from the WTRU time scheduler; and
(c) a processor electrically coupled to the memory, wherein the processor allocates at least one cluster of sub-carriers to the WTRU by performing at least one of a pilot sub-carrier allocation function, a consecutive sub-carrier allocation (CSA) function and a distributed sub-carrier allocation (DSA) function.

2. The base station of claim 1 further comprising:
(d) an antenna;
(e) a transmitter electrically coupled to the processor and the antenna; and
(f) a receiver electrically coupled to the processor and the antenna, wherein the transmits data and pilot sub-carriers to the WTRU.

3. The base station of claim 2 wherein the receiver receives feedback information including at least one channel quality indicator (CQI) from the WTRU.

4. The base station of claim 3 wherein the processor determines whether the WTRU has a large frequency domain variation or a small frequency domain variation based on the feedback information.

5. The base station of claim 4 wherein the base station determines whether to implement DSA or CSA based on whether the frequency domain variation is determined to be large or small.

6. The base station of claim 3 wherein the processor determines whether the WTRU has a fast time domain variation or a slow time domain variation based on the feedback information.

7. The base station of claim 6 wherein the base station determines whether to implement DSA or CSA based on whether the time domain variation is determined to be fast or slow.

8. The base station of claim 1 wherein the WTRU time scheduler, the allocation information memory and the processor are incorporated into an integrated circuit (IC).

9. In an orthogonal frequency division multiple access (OFDMA) system including at least one base station and a plurality of wireless transmit/receive units (WTRUs), a hybrid sub-carrier allocation method for data transmissions to multiple access WTRUs, the method comprising:
(a) the plurality of WTRUs receiving data and pilot sub-carriers from the base station;
(b) the base station determining whether each WTRU has a large or small frequency domain variation;
(c) the base station determining whether each WTRU has a fast or slow time domain variation; and
(d) the base station determining whether to implement a distributed sub-carrier allocation (DSA) or a consecutive sub-carrier allocation (CSA) based on the determinations of steps (b) and (c).

10. The method of claim 9 further comprising:
(e) each of the WTRUs measuring channel qualities for each pilot sub-carrier;
(f) each of the WTRUs measuring time and frequency variation of channel qualities; and
(g) each of the WTRUs sending feedback information to the base station.

11. In an orthogonal frequency division multiple access (OFDMA) system including at least one base station and a plurality of wireless transmit/receive units (WTRUs), a hybrid sub-carrier allocation method for data transmissions to multiple access WTRUs, where sub-carriers are allocated according to a first sub-carrier allocation type and a second sub-carrier allocation type, the method comprising:
transmitting a pilot signal with distributed pilot sub-carriers;
measuring at each WTRU a channel quality metric for each pilot sub-carrier;
sending feedback from each WTRU to the base station reporting a channel quality indicator (CQI) based on the measured channel quality metrics; and
selecting either the first or the second sub-carrier allocation type for each individual WTRU based on the CQI.

12. The method of claim 11, wherein the first sub-carrier allocation type is consecutive sub-carrier allocation (CSA) and the second sub-carrier allocation type is distributed sub-carrier allocation (DSA).

13. The method of claim 11 further comprising:
performing adaptive switching of sub-carrier allocation controlled by characterizing time and frequency domain channel characteristics of each WTRU.

14. The method of claim 11 further comprising:
measuring variation of channel quality of one or more pilot sub-carriers in time domain to derive a time variation value Vt.

15. The method of claim 11 further comprising:
measuring variation of channel quality between the pilot sub-carriers in frequency domain at a time instance to derive a frequency variation value Vf.

16. The method of claim 13 wherein the characterizing of the time domain characteristics of each WTRU is defined as a fast time variation for a time variation value Vt greater than a predetermined threshold value T_fast, and is defined as a slow time variation for a time variation value Vt less than a second predetermined threshold value T_slow.

17. The method of claim 16 wherein T_fast>T_slow.

18. The method of claim 16 wherein T_fast=T_slow.

19. The method of claim 13 wherein the characterizing of the frequency domain characteristics of each WTRU is defined as a large frequency variation for a frequency variation value Vf greater than a predetermined threshold value F_large and defined as a small frequency variation for a frequency variation value less than a predetermined threshold value F_small.

20. The method of claim 20 wherein F_large>F_small.

21. The method of claim 20 wherein F_large=F_small.

22. In an orthogonal frequency division multiple access (OFDMA) system including at least one base station and a plurality of wireless transmit/receive units (WTRUs), a hybrid sub-carrier allocation method for data transmissions to multiple access WTRUs, the method comprising:
(a) the plurality of WTRUs receiving data and pilot sub-carriers from the base station;
(b) each of the WTRUs performing channel quality measurements and sending feedback information to the base station based on the channel quality measurements;
(c) the base station determining whether each WTRU has a large or small frequency domain variation, Vf, based on the feedback information; and
(d) the base station determining whether each WTRU has a fast or slow time domain variation, Vt, based on the feedback information.

23. The method of claim 22 further comprising:
(e) the base station determining whether to implement a distributed sub-carrier allocation (DSA) or a consecutive sub-carrier allocation (CSA) based on the determinations of steps (c) and (d).

24. The method of claim 22 further comprising:
(e) the base station sending information to each of the WTRUs which indicates values of a first given threshold associated with the value of Vt, and a second given threshold associated with the value of Vt; and
(f) the WTRU reporting information derived from Vt and Vf to the base station, wherein the reported information includes a first bit which indicates whether Vt has exceeded the first given threshold, and a second bit which indicates whether Vf has exceeded the second given threshold.

25. In an orthogonal frequency division multiple access (OFDMA) system including at least one base station and at least one wireless transmit/receive unit (WTRU), a method comprising:
(a) the WTRU receiving data and pilot sub-carriers from the base station;
(b) the WTRU measuring a variation of channel quality of at least one of the pilot sub-carriers in time domain to determine a time variation, Vt;
(c) the WTRU measuring a variation of channel qualities between the pilot sub-carriers at a time instance to determine a frequency variation, Vf; and
(d) the WTRU autonomously taking an action based on the values of Vt and Vf.

26. The method of claim 25 wherein the WTRU determines whether a consecutive sub-carrier allocation (CSA) function or a distributed sub-carrier allocation (DSA) function should be implemented based on the values of Vt and Vf.

27. In an orthogonal frequency division multiple access (OFDMA) system including at least one base station and at least one wireless transmit/receive unit (WTRU), a method comprising:
(a) the WTRU receiving data and pilot sub-carriers from the base station;
(b) the WTRU measuring a variation of channel quality of at least one of the pilot sub-carriers in time domain to determine a time variation, Vt;
(c) the WTRU measuring a variation of channel qualities between the pilot sub-carriers at a time instance to determine a frequency variation, Vf; and
(d) the WTRU reporting information derived from Vt and Vf to the base station.

28. The method of claim 27 wherein the reported information includes a first bit which indicates whether Vt has exceeded a first given threshold, and a second bit which indicates whether Vf has exceeded a second given threshold.

29. The method of claim 28 further comprising:
(e) The base station sending information to the WTRU which indicates values of the first and second given thresholds.

30. The method of claim 27 wherein the WTRU determines whether a consecutive sub-carrier allocation (CSA) function or a distributed sub-carrier allocation (DSA) function should be implemented based on the values of Vt and Vf.

31. The method of claim 27 wherein the base station determines whether a consecutive sub-carrier allocation (CSA) function or a distributed sub-carrier allocation (DSA) function should be implemented based on the values of Vt and Vf.
